(19) United States
(12) Patent Application Publication
(10) Pub. No.: US 2024/0140068 A1
(43) Pub. Date: May 2, 2024

(54) GLASS LIGHTPROOF AND SUN-SHADING HEAT INSULATION FILM THAT IS PASTED TO USE REPEATEDLY

(71) Applicants: Andy Kuan-Yu CHEN, Taipei City (TW); Wei-Yang CHEN, Singapore (SG)

(72) Inventors: Andy Kuan-Yu CHEN, Taipei City (TW); Wei-Yang CHEN, Singapore (SG)

(21) Appl. No.: 18/498,847

(22) Filed: Oct. 31, 2023

(30) Foreign Application Priority Data
Nov. 1, 2022 (TW) 111211949

(51) Int. Cl. B32B 7/12; B32B 27/08; B32B 27/30; B32B 27/36; B32B 27/40; B32B 33/00

(52) U.S. Cl. CPC B32B 7/12; B32B 27/08; B32B 27/304; B32B 27/36; B32B 27/40; B32B 33/00; B32B 2307/304; B32B 2307/41

(57) ABSTRACT

A glass lightproof and sun-shading heat insulation film that is pasted to use repeatedly, belongs to the technical area of a protective film and includes a thermal-insulation surface film. A bottom of the thermal-insulation surface film is a soft statics adsorption film, and a bottom of the soft statics adsorption film is a protective base film. In pasting the heat insulation film, there is no need to use a sticker to connect the glass to the heat insulation film. Therefore, the probability of leaving the sticker on the glass surface is reduced, which decreases the difficulty in pasting the film and lowers the difficulty in cleaning the old heat insulation film. The products of glass heat insulation film can be accepted and used by more people, and when a car is flooded abruptly or falls into water accidentally, a user can break the glass window more easily to survive.

### BACKGROUND OF THE INVENTION

### (a) Field of the Invention

The present invention relates to a protective film, and more particularly to a glass lightproof and sun-shading heat insulation film that is pasted to use repeatedly.

### (b) Description of the Prior Art

As glass material is widely used in the daily life, the glass stick-film has been gradually used in homes. In nowadays, the glass stick-film is everywhere in houses, office buildings or vehicles, and is generally applied to glass windows or glass partition walls. Many people have seen that a layer of glass stick-film is pasted on glass, and this glass stick-film has many functions, e.g., it can block the sun and prevent the ultraviolet light from entering into the room to insulate heat and prevent the ultraviolet light. In addition, the glass stick-film also provides the glass with a function of shielding from strong glare coming from the sun.

In terms of the abovementioned technology, the present inventor believes there exists following shortcomings. For the conventional heat insulation film, glass is connected to the heat insulation film by a sticker. Therefore, it demands a higher pasting technology to a worker upon installing the heat insulation film. In addition, when the worker replaces the heat insulation film, the sticker can be left on the glass easily, which increases the difficulty in cleaning the old heat insulation film. Therefore, how to solve the abovementioned issues for improvement is the direction of research by the present inventor.

### SUMMARY OF THE INVENTION

To reduce the difficulty in pasting the film and lower the difficulty in cleaning the old heat insulation film, the present invention provides a glass lightproof and sun-shading heat insulation film that is pasted to use repeatedly.

To achieve the abovementioned object, the present invention discloses a glass lightproof and sun-shading heat insulation film that is pasted to use repeatedly, comprising a thermal-insulation surface film. A bottom of the thermal-insulation surface film is provided with a soft statics adsorption film, and a bottom of the soft statics adsorption film is provided with a protective base film.

By the abovementioned technology, when the worker is to install the heat insulation film on glass, he or she only needs to cut a roll of heat insulation film into the required specification and clean up the surface of glass to be pasted. After that, the worker rips off the protective base film and sprays pure water on the surface of glass to be pasted. Next, the worker pastes the heat insulation film on the surface of glass to be pasted. Finally, the worker only needs to scrape off air bubbles in the heat insulation film by a scraper.

In pasting the heat insulation film, there is no need to use the sticker to connect the glass to the heat insulation film. Therefore, the probability of leaving the sticker on the glass surface is reduced, which decreases the difficulty in pasting the film and lowers the difficulty in cleaning the old heat insulation film.

Furthermore, the upper surface of the thermal-insulation surface film is provided with an anti-abrasion and wear-resistant coating, which improves the wear resistance of the heat insulation film and increases the service life of the heat insulation film.

Furthermore, the thermal-insulation surface film is provided with a nano-metal reflection coating, an IR (Infrared) heat insulation coating and a UV (Ultraviolet) absorbent coating. The nano-metal reflection coating is disposed on a bottom of the thermal-insulation surface film, the IR heat insulation coating is disposed on a bottom of the nano-metal reflection coating, and the UV absorbent coating is disposed on a bottom of the IR heat insulation coating. When the sun light and other strong light irradiates on glass of a car, the nano-metal reflection coating will reflect part of the strong light, which diminishes the intensity of strong light and reduces the probability of dazzle to a person in the car under a long time exposure to the strong light. In addition, the IR heat insulation film can effectively improve the heat insulation effect of glass. Besides that, the UV absorbent coating can protect a human body from harm, and interior equipment can be free from aging and discoloration, which improves the comfortableness of people sitting next to the glass window and increases the experiences in using the heat insulation film.

Furthermore, the bottom of the thermal-insulation surface film is provided with a composite-glue adhesive coating to improve the overall stability of the heat insulation film.

Furthermore, the soft statics adsorption film is disposed on a bottom of the composite-glue adhesive coating to reduce the probability that the thermal-insulation surface film is separated from the soft statics adsorption film.

Furthermore, the soft statics adsorption film is made of PVC (Polyvinyl Chloride) or TPU (Thermoplastic Polyurethane). As PVC and TPU are provided with an excellent adhesive force, a low viscosity and a good anti-bending capability, the soft statics adsorption film can have a good adsorption effect and can defend any exposure, including the UV light, thereby increasing the service life of heat insulation film.

Furthermore, the protective base film is made of PET (Polyethylene Terephthalate); PET is oil-proofed, grease-proofed, anti-diluted acid, and anti-diluted base, as well as can withstand most solvents, which enables the protective base film to have a good protection effect, thereby reducing the probability of damaging the heat insulation film.

Accordingly, the present invention provides a glass lightproof and sun-shading heat insulation film that is pasted to use repeatedly, comprising the thermal-insulation surface film, the bottom of which is provided with the soft statics adsorption film, and with the bottom of soft statics adsorption film being provided with the protective base film.

In comparison with the existing technology, the present embodiment includes at least one following benefit that:
(1) In the present invention, when the worker is to install the heat insulation film on glass, he or she only needs to cut a roll of heat insulation film into the required specification and clean up the surface of glass to be pasted. After that, the worker rips off the protective base film and sprays pure water on the surface of glass to be pasted. Next, the worker pastes the heat insulation film on the surface of glass to be pasted. Finally, the worker only needs to scrape off air bubbles in the heat insulation film by a scraper. In pasting the heat insulation film, there is no need to use the sticker to connect the glass to the heat insulation film. Therefore, the probability of leaving the sticker on the glass surface is reduced, which decreases the difficulty in pasting the film and lowers the difficulty in cleaning the old heat insulation film.
(2) In the present invention, PVC and TPU are provided with the excellent adhesive force, low viscosity and good anti-bending capability, so that the soft statics adsorption film can have the good adsorption effect, thereby increasing the convenience in installing and pasting the heat insulation film.
(3) In the present invention, PET is oil-proofed, grease-proofed, anti-diluted acid, and anti-diluted base, as well as can withstand most solvents, which enables the protective base film to have the good protection effect, thereby reducing the probability of damaging the heat insulation film.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural view of the present invention.

FIG. 2 shows an exploded view of the present invention.

FIG. 3 shows another structural view of the present invention.

### DETAILED DESCRIPTION OF THE PREFERRED EMBODIMENTS

Hereinafter, combining with the drawings in the present embodiment, the technical solution of the present embodiment is described clearly and comprehensively. Obviously, the embodiment described is only part of the embodiments in the present invention, not the entire embodiments. Based upon the present embodiment, all other embodiments achieved by a skilled person with common knowledge in the present technical field without making an advanced effort still belong to the claims protected by the present invention.

In the description of present invention, the terminology describing direction or position, e.g. “center, longitudinal, lateral, length, width, thickness, up, down, front, rear, left, right, vertical, horizontal, top, bottom, interior, exterior, clockwise, counterclockwise,” is based upon the drawings. It is merely used to facilitate describing the present invention and to simplify the description, not indicating or implying that the referred device or part must have the specific orientation, and be constructed and operated in the specific orientation. Therefore, it should not be recognized as the restriction to the present invention. In addition, the terminology of “first, second” is merely used to describe the purpose, not to be understood as specifying or implying the relative importance or implicitly specifying the quantity of the referred technical feature. Therefore, defining the feature of “first, second” can explicitly or implicitly include one or more features. In the description of present invention, except for accurate and specific restrictions otherwise, the definition of “plural” is two or more than two.

In the description of present invention, except for accurate regulations and restrictions otherwise, the terminology of “installation, interconnection, connection” should be comprehended generally. For example, it can be a fixed connection, a removable connection, or an integral connection. Moreover, it can be a mechanical connection, an electric connection, an inter-communication or a direct connection. In addition, it can be also an indirect connection by an intermediate medium, an interior connection between two parts or an interaction between two parts. A skilled person with common knowledge in the present technical field can comprehend the specific meaning of the abovementioned terminology in the present invention, according to the specific condition.

In the present invention, except for accurate regulations and restrictions otherwise, the description of that the first feature is above or below the second feature can include that the first feature contacts the second feature directly, and can also include that the first feature does not contact the second feature directly but through other feature between the two. Besides that, the description of that the first feature is above, at an upper side of, or on top of the second feature includes that the first feature is directly above or diagonally above the second feature, or merely represents that the level of first feature is higher than the level of second feature. The description of that the first feature is below, at a lower side of, or on bottom of the second feature includes that the first feature is directly below or diagonally below the second feature, or merely represents that the level of first feature is lower than the level of second feature.

The description below provides many various implementation methods or examples to implement the different structures in the present invention. To simplify the description of present invention, hereinafter the description is for parts and provisions of a specific example. Obviously, they are merely used for exemplification, and are not to restrict the present invention. Moreover, in the present invention, a reference number or reference letter can be used repeatedly in various examples; this repetition is for simplification and clearness, not to specify the relationships among all implementation methods or provisions. In addition, the present invention provides all kinds of examples for a specific art and material. Yet, a skilled person with common knowledge in the present technical field can be aware of that applications to other arts or uses of other materials are available.

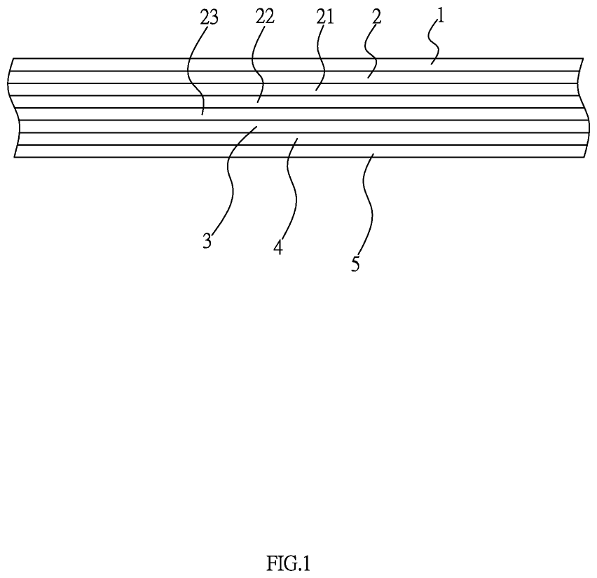

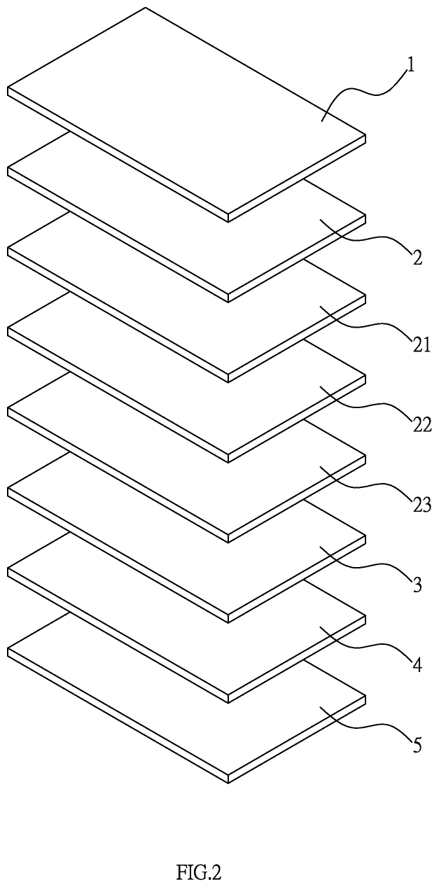

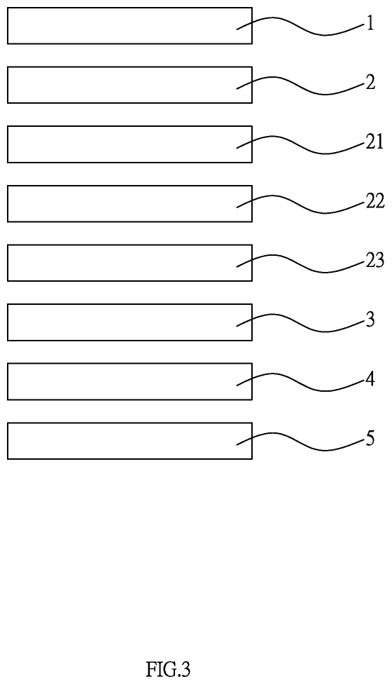

The present invention discloses a glass lightproof and sun-shading heat insulation film that is pasted to use repeatedly. Referring to FIGS. 1 to 3, the heat insulation film comprises a thermal-insulation surface film 2, a soft statics adsorption film 4, a protective base film 5, and an anti-abrasion and wear-resistant coating 1. The thermal-insulation surface film 2 includes a nano-metal reflection coating 21, an IR heat insulation coating 22, and a UV absorbent coating 23. The thermal-insulation surface film 2 is a horizontal plate structure, the soft statics adsorption film 4 is also a horizontal plate structure, and is made of PVC or TPU. The soft statics adsorption film 4 is disposed on a bottom of the thermal-insulation surface film 2. The protective base film 5 is a horizontal plate structure and is made of PET. The protective base film 5 is disposed on a bottom of the soft statics adsorption film 4. The anti-abrasion and wear-resistant coating 1 is a horizontal plate structure and is disposed on an upper surface of the thermal-insulation surface film 2, in order to improve the wear-resistance of the heat insulation film, reducing the probability of damage to the heat insulation film.

The nano-metal reflection coating 21 is a horizontal plate structure made of nano material, and is disposed on a bottom of the thermal-insulation surface film 2. The IR heat insulation coating 22 is a horizontal plate structure, and is disposed on a bottom of the nano-metal reflection coating 21. The UV absorbent coating 23 is a horizontal plate structure, and is disposed on a bottom of the IR heat insulation coating 22. When sun light or other strong light irradiates on a glass window of car, the nano-metal reflection coating 21 will reflect part of the strong light, reducing the intensity of strong light and decreasing the probability of dazzle to people in the car under a long time irradiation by the strong light. In addition, the IR heat insulation coating 22 can improve the heat insulation effect of glass effectively. Furthermore, the UV absorbent coating 23 can protect a human body from damage, and interior equipment can be free from aging and discoloration, thereby improving the comfortableness of people sitting next to the glass window and increasing the experience in using the heat insulation film.

To reduce the probability that the thermal-insulation surface film 2 is separated from the soft statics adsorption film 4, the bottom of the thermal-insulation surface film 2 is provided with a composite-glue adhesive coating 3, and the soft statics adsorption film 4 is disposed on a bottom of the composite-glue adhesive coating 3.

The present embodiment provides a glass lightproof and sun-shading heat insulation film that is pasted to use repeatedly, comprising a thermal-insulation surface film 2. The bottom of the thermal-insulation surface film 2 is provided with the soft statics adsorption film 4, and the bottom of the soft statics adsorption film 4 is provided with the protective base film 5. The implementation principle of the present embodiment is described as follows. When the worker is to install the heat insulation film on glass, he or she only needs to cut a roll of heat insulation film into the required specification and clean up the surface of glass to be pasted. After that, the worker rips off the protective base film 5 and sprays pure water on the surface of glass to be pasted. Next, the worker pastes the heat insulation film on the surface of glass to be pasted; and finally, the worker only needs to scrape off the air bubbles in the heat insulation film by the scraper.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A glass lightproof and sun-shading heat insulation film that is pasted to use repeatedly, comprising a thermal-insulation surface film, wherein a bottom of the thermal-insulation surface film is provided with a soft statics adsorption film, and a bottom of the soft statics adsorption film is provided with a protective base film.

2. The glass light-proof and sun-shading heat insulation film that is pasted to use repeatedly, according to claim 1, wherein an upper surface of the thermal-insulation surface film is provided with an anti-abrasion and wear-resistant coating.

3. The glass lightproof and sun-shading heat insulation film that is pasted to use repeatedly, according to claim 1, wherein the thermal-insulation surface film is provided with a nano-metal reflection coating, an IR (Infrared) heat insulation coating and a UV (Ultraviolet) absorbent coating.

4. The glass lightproof and sun-shading heat insulation film that is pasted to use repeatedly, according to claim 2, wherein the thermal-insulation surface film is provided with a nano-metal reflection coating, an IR (Infrared) heat insulation coating and a UV (Ultraviolet) absorbent coating.

5. The glass lightproof and sun-shading heat insulation film that is pasted to use repeatedly, according to claim 3, wherein the nano-metal reflection coating is disposed on a bottom of the thermal-insulation surface film, the IR (Infrared) heat insulation coating is disposed on a bottom of the nano-metal reflection coating, and the UV absorbent coating is disposed on a bottom of the IR heat insulation coating.

6. The glass lightproof and sun-shading heat insulation film that is pasted to use repeatedly, according to claim 4, wherein the nano-metal reflection coating is disposed on a bottom of the thermal-insulation surface film, the IR (Infrared) heat insulation coating is disposed on a bottom of the nano-metal reflection coating, and the UV absorbent coating is disposed on a bottom of the IR heat insulation coating.

7. The glass lightproof and sun-shading heat insulation film that is pasted to use repeatedly, according to claim 1, wherein a bottom of the thermal-insulation surface film is provided with a composite-glue adhesive coating.

8. The glass lightproof and sun-shading heat insulation film that is pasted to use repeatedly, according to claim 7, wherein the soft statics adsorption film is disposed on a bottom of the composite-glue adhesive coating.

9. The glass lightproof and sun-shading heat insulation film that is pasted to use repeatedly, according to claim 8, wherein the soft statics adsorption film is made of PVC (Polyvinyl Chloride) or TPU (Thermoplastic Polyurethane).

10. The glass lightproof and sun-shading heat insulation film that is pasted to use repeatedly, according to claim 1, wherein the protective base film is made of PET (Polyethylene Terephthalate).
